(19) United States
(12) Patent Application Publication
(10) Pub. No.: US 2005/0050875 A1
(43) Pub. Date: Mar. 10, 2005

(54) Method and apparatus for harvesting food products

(75) Inventors: J. Kevin Alsobrook, Yuma, AZ (US); R. Kent Addison, Salinas, CA (US); James Aikins, Modesto, CA (US)

Correspondence Address: DUCKOR SPRADLING METZGER, 401 WEST A STREET, SUITE 2400, SAN DIEGO, CA, 92101-7915, US

(73) Assignee: Fresh Innovation, LLC

(21) Appl. No.: 10/932,661

(22) Filed: Sep. 2, 2004

Related U.S. Application Data
(60) Provisional application No. 60/500,441, filed on Sep. 5, 2003.

(51) Int. Cl. A01D 13/00

(52) U.S. Cl. 56/327.1

(57) ABSTRACT

The disclosed embodiments relate to methods and apparatus for harvesting plants from the soil, including the extracting of the plants from the soil and placing them in containers such as totes. In order to deposit the harvested plants in the containers, the plants are re-oriented into generally horizontal dispositions and positioned within the containers.

### RELATED APPLICATION

This application claims priority to U.S. provisional patent application, Application No. 60/500,441, filed Sep. 5, 2003, and entitled METHOD AND APPARATUS FOR HARVESTING FOOD PRODUCTS.

### FIELD OF THE INVENTION

The present invention relates in general to a method and apparatus for harvesting food products. It more particularly relates to such a method and apparatus for harvesting food products such as green onions.

### BACKGROUND ART

This section describes the background of the disclosed embodiments of the present invention. There is no intention, either express or implied, that the background art discussed in this section legally constitutes prior art.

Currently, certain types of vegetables such as green onions, are essentially harvested by hand. In this regard, it has been difficult to construct automatic equipment for harvesting green onions and similar vegetables, since they are each somewhat unique in size and shape.

Thus, mechanical equipment for removing the product from the ground and then bunching them together is a difficult task to do mechanically as a result of the different sizes and shapes of the product.

### BRIEF DESCRIPTION OF THE DRAWINGS

The following is a brief description of the drawings:

FIGS. 1 and 2 are partially diagrammatic pictorial views of a harvesting apparatus, which is constructed in accordance with an embodiment of the invention;

FIG. 3 is a partially diagrammatic side elevational view of a portion of the harvesting apparatus of FIG. 1, illustrating the conveying of the extracted plants upwardly onto the harvester of FIG. 1 and illustrating a pneumatic reorienting and discharging mechanism;

FIG. 4 is a partially diagrammatic view of a separator of the harvester of FIG. 1;

FIG. 5 is a sectional view of the separator of FIG. 4 taken substantially on line 5-5;

FIG. 6 is a diagrammatic pictorial enlarged view of the conveyors of the harvester of FIG. 1;

FIG. 7 is an enlarged pictorial diagrammatic view of one pair of pinch conveyors of the conveyors of FIG. 6;

FIG. 8 is a top plan view of the separator of FIG. 4;

FIG. 9 is an enlarged pictorial diagrammatic view of the separator of FIG. 4, illustrating it in a closed position;

FIG. 10 is an enlarged diagrammatic pictorial view of the separator of FIG. 4, similar to FIG. 9 illustrating the separator in its opened position; and

FIGS. 11-15 are diagrammatic views of another harvester which is constructed according to another embodiment of the invention.

FIG. 16 is a partially diagrammatic side elevational view of another harvester, which is constructed in accordance with another embodiment of the invention;

FIG. 17 is an enlarged fragmentary pictorial partially diagrammatic view of the harvester of FIG. 16, illustrating a foam conveyor assembly and a rotating reorienting and discharging mechanism.

FIG. 18 is an enlarged pictorial diagrammatic view of the rotating reorienting and discharging mechanism of FIG. 17;

FIG. 19 is a bottom plan view of the reorienting and discharging mechanism of FIG. 17.

FIG. 20 is a side elevational diagrammatic view of the rotating reorienting and discharging mechanism of FIG. 17, illustrating it in the process of operation.

FIG. 21 is an enlarged pictorial diagrammatic view of the harvesting apparatus in FIG. 16, illustrating a flexible disc of the reorienting and discharging mechanism.

### DETAILED DESCRIPTION OF CERTAIN EMBODIMENTS OF THE INVENTION

The disclosed embodiments relate to methods and apparatus for harvesting plants from the soil, including the extracting of the plants from the soil and placing them in containers such as totes. In order to deposit the harvested plants in the containers, the plants are re-oriented into generally horizontal dispositions and positioned within the containers.

According to certain embodiments of the invention, there is provided a method and apparatus for harvesting plants from the soil. In one disclosed embodiment, the harvesting includes reorienting and discharging the extracted plants into containers or totes via at least one pneumatic driven reorienting and discharging mechanism that includes a product transfer tube and a product separator. In another disclosed embodiment, the harvesting includes reorienting and discharging the extracted plants into containers or totes via at least one rotating reorientation and discharging mechanism that includes two rotating discs employing spreader rollers and pinch rollers for receiving the plants and re-orienting the received plants to deposit them into the containers.

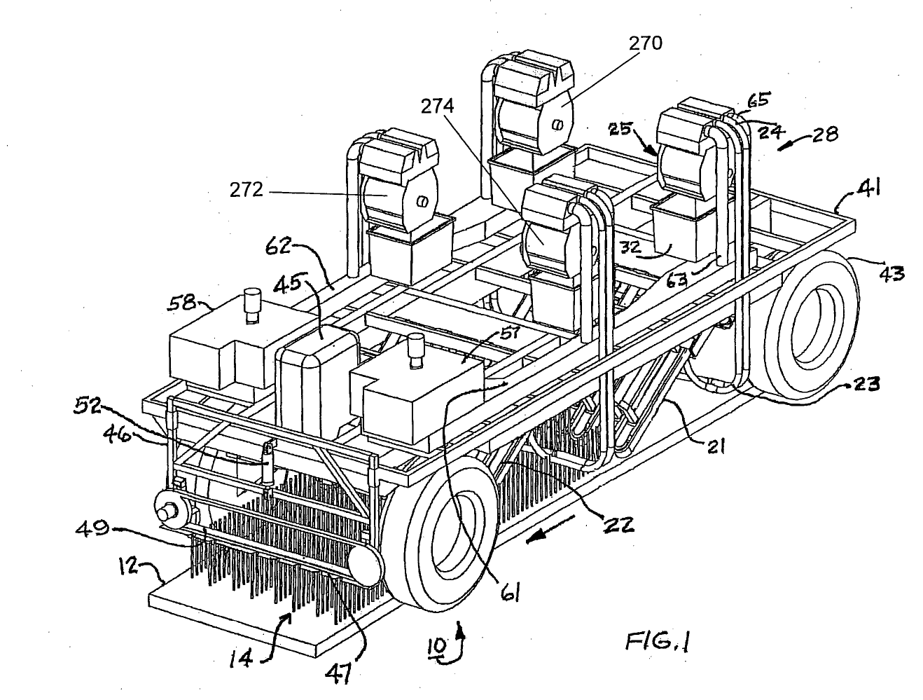

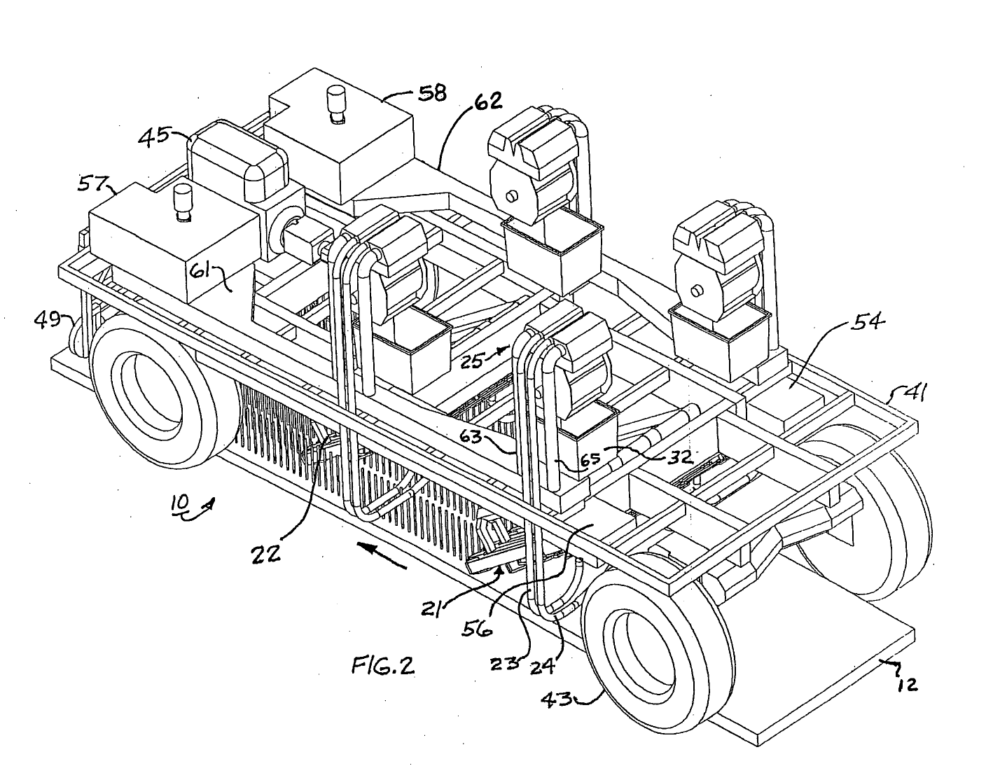

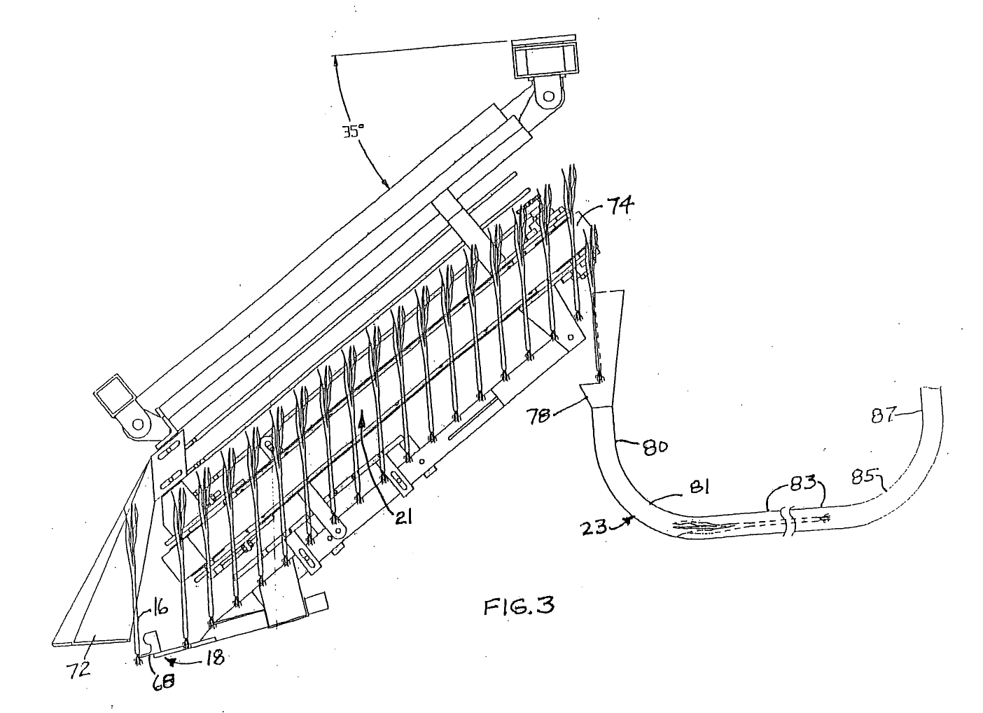

Referring now to the drawings, and more particularly to FIGS. 1 and 2 thereof, there is shown a harvester 10, which is constructed in accordance with an embodiment of the present invention, and which is used to harvest plants from a soil bed 12 having a series of spaced-apart seed rows such as the seed row 14. The harvester 10 is able to harvest substantially all or part of the seed rows of the bed 12 in one or more swaths. The food products such as a green onion 16 (FIG. 3) is removed from the soil bed 12 by means of a plant extractor 18 including a digger 68 and then directed via an infeed guide mechanism generally indicated at 67 and 72 as shown in FIGS. 3, 6 and 7.

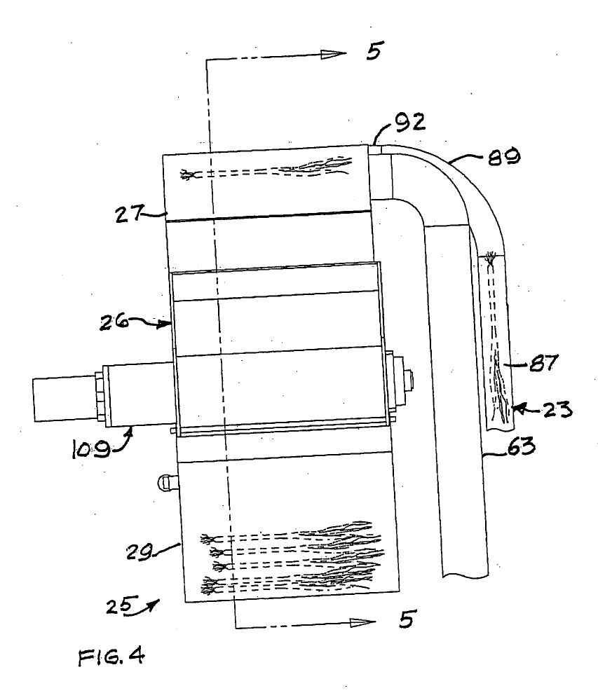

A pair of transversely staggered pinch belt conveyor assemblies 21 and 22 as shown in FIGS. 1 and 2 each have four conveyors to transport the extracted plants such as the green onion 16 upwardly at an angle of approximately 35 degrees from the horizontal away from the 8 but not limited to seed lines of the seed bed 12. A pneumatic reorienting and discharging mechanism generally indicated at 28 includes a pneumatic product transfer tube such as the pneumatic product transfer tube 23 (FIG. 3) that receives the extracted onions from the conveyors such as the conveyor 21. A product separator such as product separator 25 that is also part of the reorienting and discharging mechanism 28 receives the onions such as the onion 16 (FIG. 3) via the transfer tube 23. The onions are ejected into the interior of a housing 26 of the separator 25 to abruptly stop when hitting a wall 27 (FIG. 4) of the housing 26. Separator 25 may also receive onions from other pneumatic product transfer tubes such as the pneumatic product transfer tube 24 that receives the extracted onions from other conveyors. Multiple separators such as separators 270, 272, 274 (FIG. 1) may also receive onions from other pneumatic product transfer tubes.

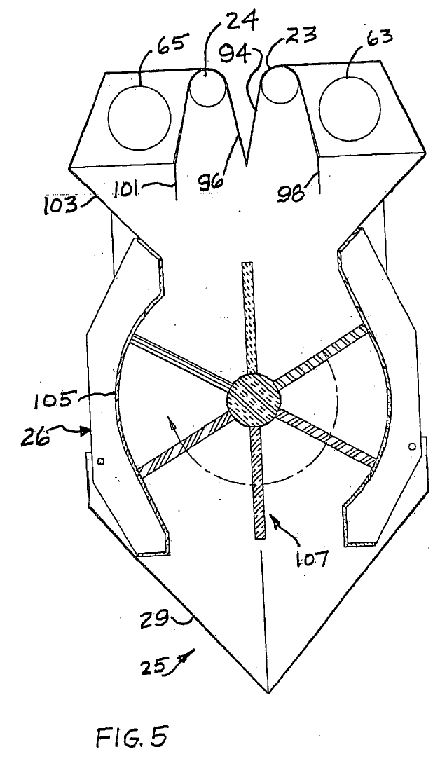

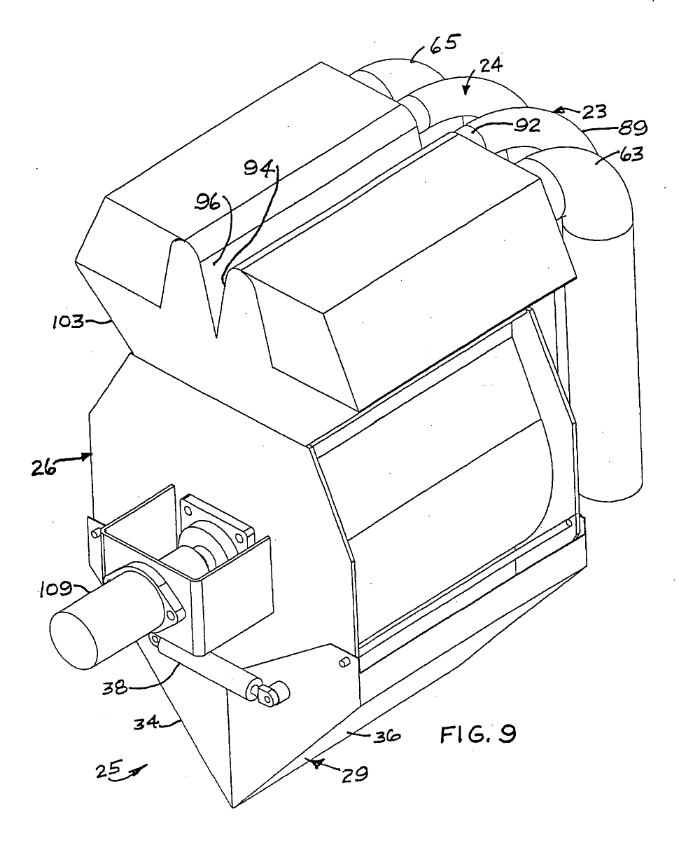

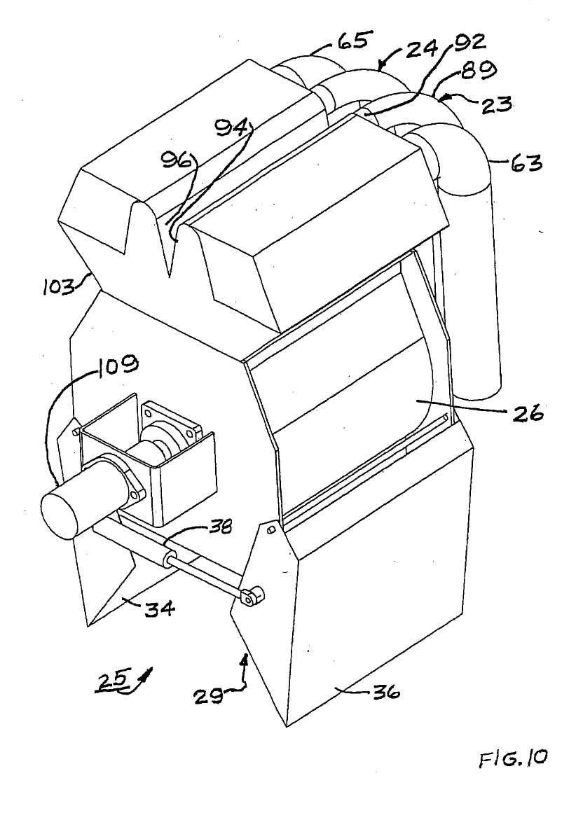

As shown in FIGS. 5, 9 and 10, the separator 25 includes a V-shaped drop gate generally indicated at 29 to drop accumulations of the onions into the tote 32. Once the tote such as the tote 32 (FIG. 1) is filled, it is removed from under the separator 25 and an empty tote is then placed under the separator 25. The V-shaped drop gate 29 includes a pair of gates 34 and 36 as shown in FIGS. 9 and 10. A piston cylinder assembly 38 controls the movement of the gates 34 and 36 so that they can be opened as shown in FIG. 10 to drop an accumulation of the onions into the tote 32. Thus, the reorienting and discharging mechanism 28 containing both the pneumatic product transfer tube 23 and the separator 25 combinationally function to take vertically disposed onions, such as onion 16, and reorient and discharge the onion from the conveyor 21 into a horizontal disposition suitable for stacking in a container or tote 32

Considering now the harvester 10 in greater detail with reference to FIGS. 1 and 2, the harvester 10 includes a platform or bed 41, which is mounted on a set of 4 wheels such as a wheel 43. A diesel engine 45 is mounted on the front of the platform 41 and drives the wheels such as the wheel 43 to move along the ground. The wheels are spaced apart to enable the platform 41 to move above the soil bed 12 so that all of the seed rows such as the seed row 14 can be harvested in one or more passes.

A vertical frame 46 is adjustably mounted on the front end of the platform 41 and includes a horizontally-disposed power band saw 47 to sever the tops of the stalks of the onions prior to harvesting. A trash conveyor 49 is mounted on the frame 46 above the band saw 47 to remove the severed portions of the onions to discharge them into furrows (not shown). A piston cylinder assembly 52 positionally adjusts the frame 46 vertically to adjust the height of the topping of the onions.

Fuel and hydraulic oil tanks 54 and 56 are mounted on the outboard sides extending a substantial length of the platform 41 as best seen in FIG. 2. A pair of fans 57 and 58 are mounted on the front end of the platform 41 flanking the diesel engine 45 to provide negative air pressure for a pair of negative air pressure plenums 61 and 62, for providing for the air return from pairs of return air vacuum tubes such as a pair of tubes 63 and 65, for the separators such as the separator 25. Thus, the fans 57 and 58 provide the negative pressure for each one of the separators and are driven by the engine 45.

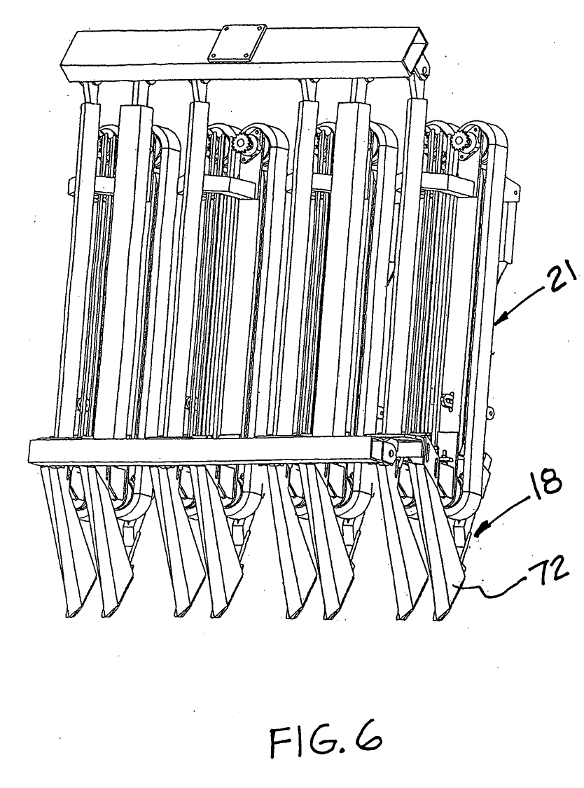

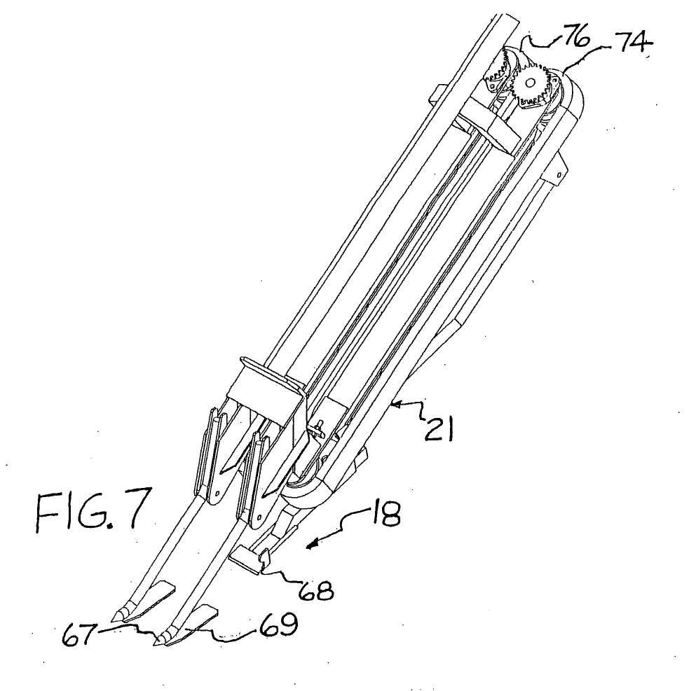

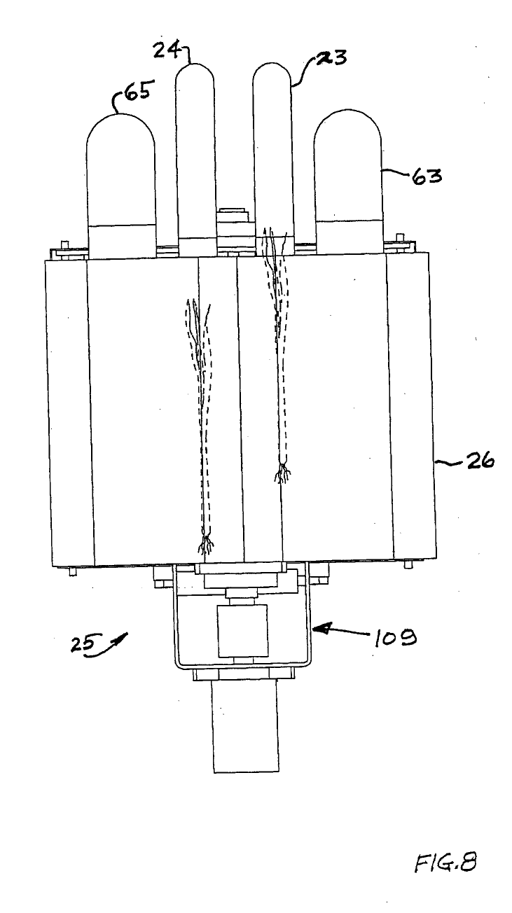

Considering the infeed guide mechanisms such as the mechanism 18, the guide mechanisms are all similar to one another, and the mechanism 67 and 72 will now be described in greater detail. As shown in FIG. 7, the mechanisms 67 or 72 includes a pair of pointed tips such as the tip 67 for helping to guide the dislodged onions. A trailing shoe 69 is connected to the tip 67 to skid along the surface of the ground. A pair of inlet feed guides such as an inlet feed guide 72 (FIG. 6) helps guide the extracted onions to engage the pinch belt conveyor 21. In this regard, should the dislodged onion lean either to the right or the left, one of the pair of guides will receive the onion and help to guide it into an upright position to then engage the pinch conveyor.

The conveyor 21 includes a pair of foam conveyor belts 74 and 76 (FIG. 7) for engaging the stalks of these extracted onions to convey them upwardly from the bed 12.

Considering now the product transfer tubes in greater detail with reference to FIG. 3, the transfer tubes are all similar to one another, and thus, only the tube 23 will now be described in greater detail. The tube 23 forms part of the pneumatic reorientation and discharges device 24 and includes a flared entrance 78 to receive the extracted onions dropping from the upper end of the conveyor belts 74 and 76. The negative air pressure within the tubes such as the tube 23, draws the onions into a fast moving airstream directing them into the interior of the separator 25.

The tube 23 includes a descending vertical tube portion 80 extending from the flared entrance 78 and interconnecting in fluid communication with a 90 degree tube transition portion 81. A horizontal tube portion 83 connects in fluid communication the transition portion 81 to a 90 degree tube transition portion 85, which is connected in fluid communication with a vertical ascending tube portion 87. The tube portion 87 conveys the dislodged onions vertically upwardly to the separator 25.

As best seen in FIG. 4, a 90 degree tube transition portion 89 is connected in fluid communication with the upper end of the vertical ascending tube portion 87 and with a horizontal exit stub tube portion 92, which is connected in fluid communication with the interior of the separator housing 26.

The transfer tubes 23 and 24 as best seen in FIG. 5 are connected in fluid communication with a pair of inverted diverging flared housing portions 94 and 96 at the upper portion of the housing 26 to drop the onions delivered by the transfer tubes 23 and 24. A pair of baffles 98 and 101 help direct the falling onions into a diverging funnel shaped portion 103 of the housing 26 to direct the onions into a cylindrical portion 105 of the housing 26. A set of rotating seal vanes 107 are mounted within the cylindrical housing portion 105 to provide an air lock to permit the falling onions to enter the V-shaped drop gate 29. A motive means 109 such as an electric motor or a hydraulic motor is used to rotate the vanes 107.

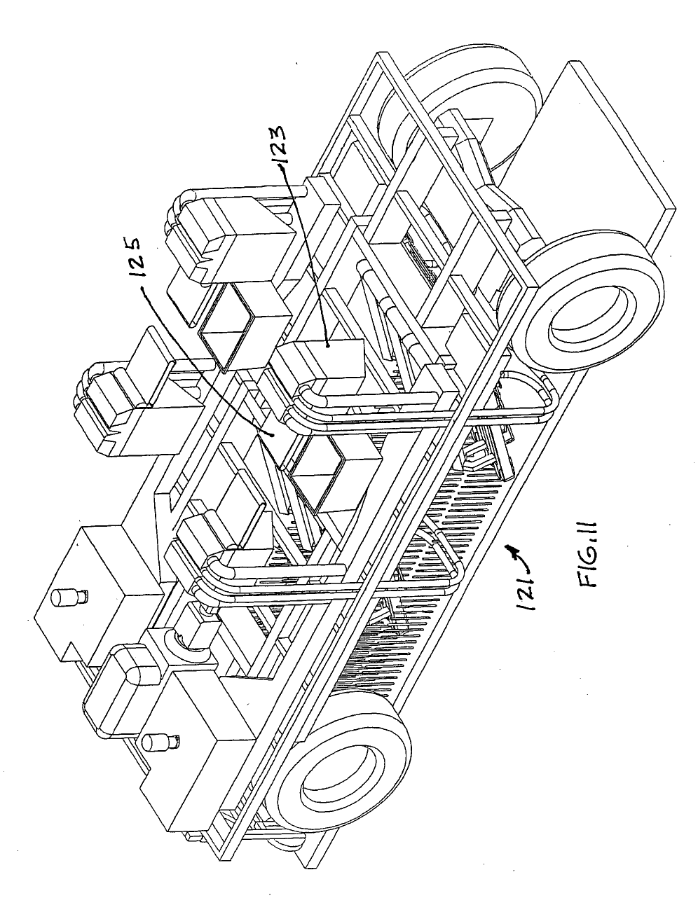

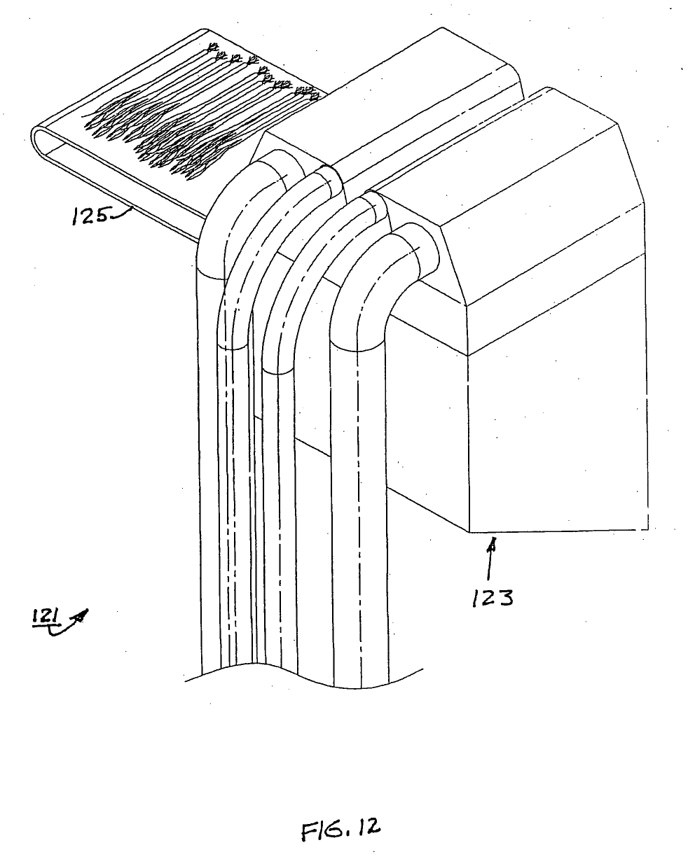

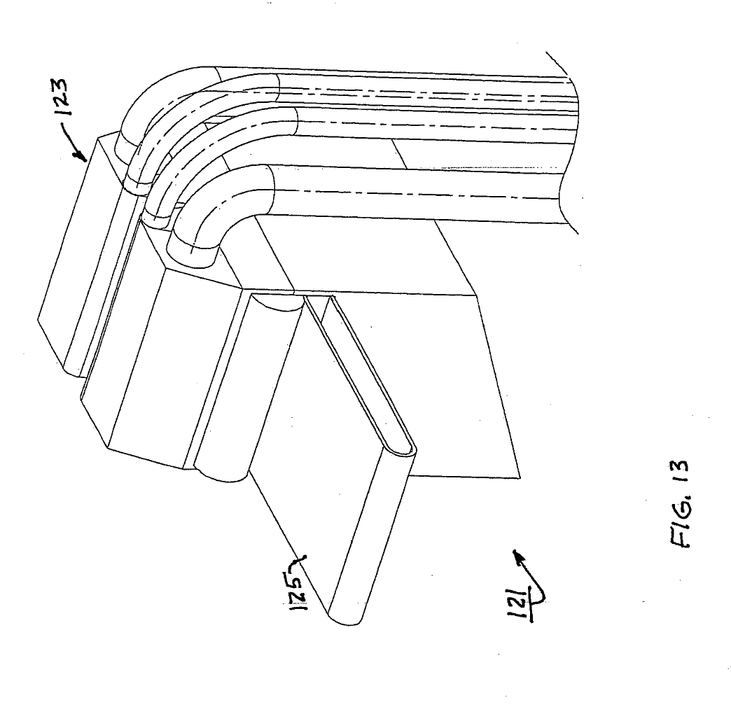

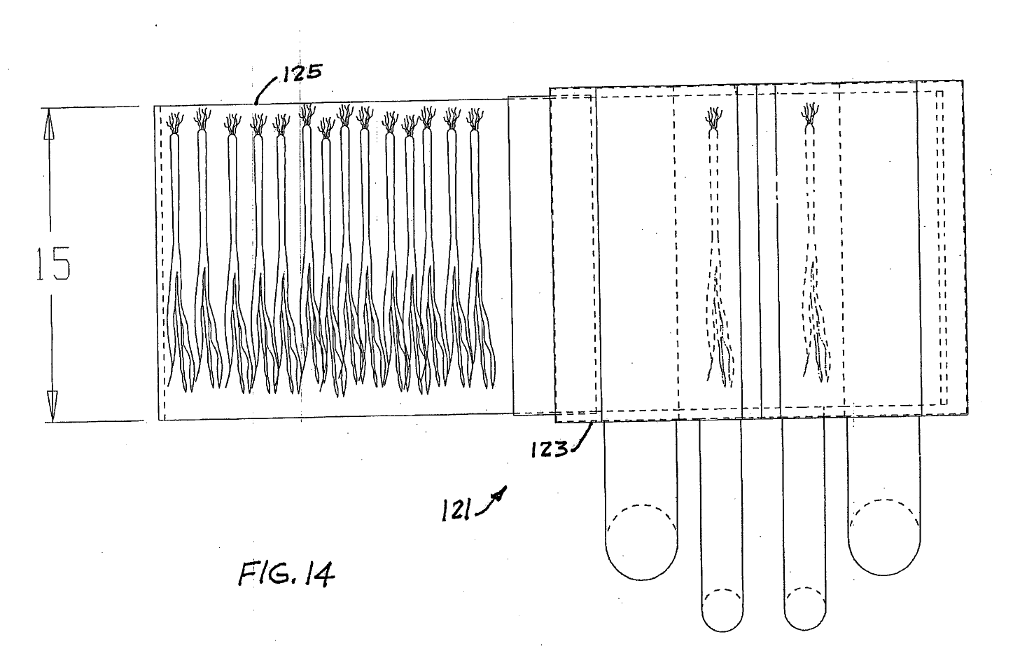

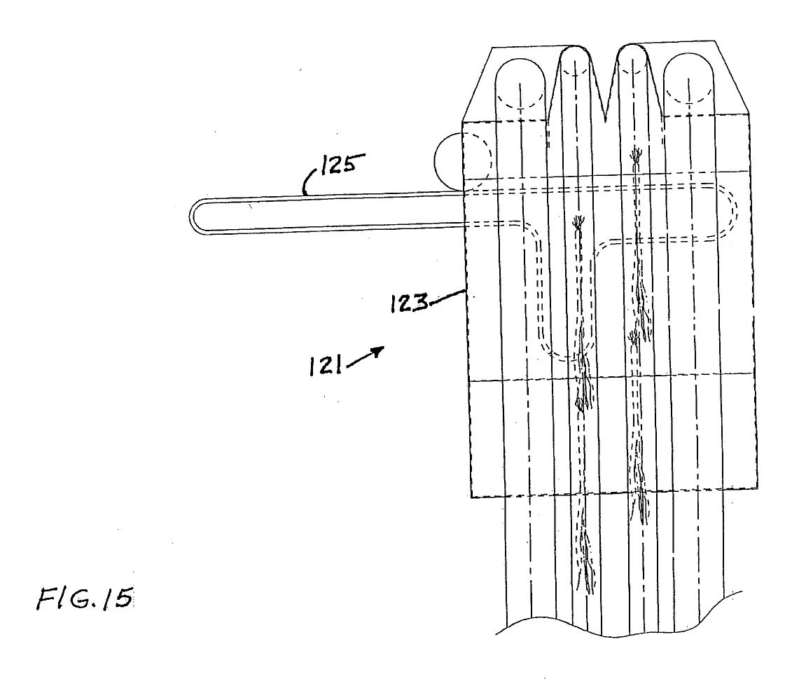

Referring now to FIGS. 11-15, there is shown another harvester 121, which is constructed according to another embodiment of the invention. The harvester 121 is generally similar to the harvester 10, except that a set of vacuum plenums such as a vacuum plenum 123 having a sealed discharge conveyor belt 125 is used.

It is to be understood that other means of creating the suction for transferring the food products may also be employed. For example, a compressed air injector system, such as the one marketed under the trade name Line Vac by Exair, may also be used.

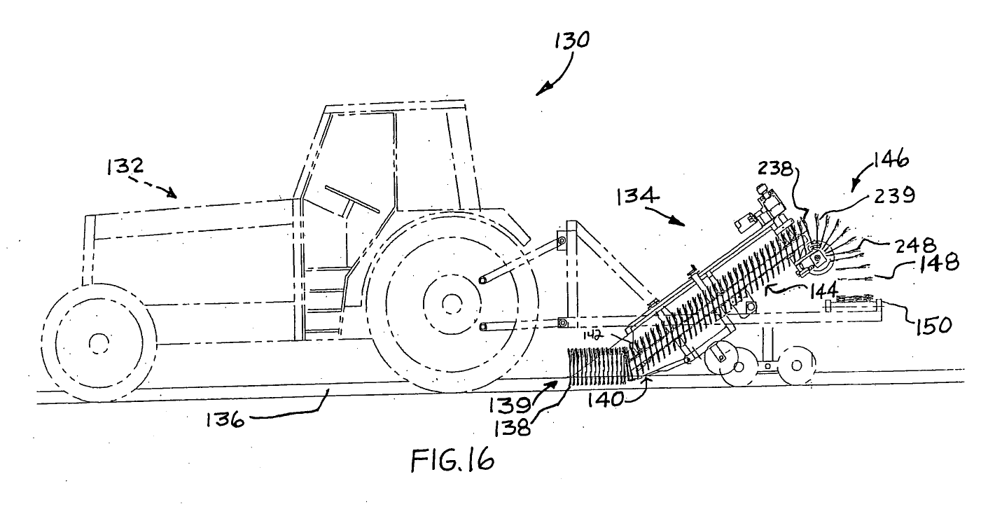

According to still another one of the disclosed embodiments of the invention and with reference to FIG. 16, a tractor pulled harvester 130 is shown which includes a harvester 134 attached to a tractor 132 or other such vehicle such as a truck. It should also be understood that the harvester 130 may also be self propelled. The tractor 132 functions to pull the harvester 134 over a soil bed 136. The soil bed 136 is similar to the soil bed 12 discussed hereinabove and has a series of spaced-apart rows, such as row 139. The soil bed 136 may contain a variety of different plants for harvesting, and such plants may include green onions such as the green onion 138.

The plants disposed in a row such as the row 139 are removed from the soil bed 136 by means of a plant extractor shown generally at 140. The plant extractor 140 includes a digger that is similar to the digger 68 shown in FIG. 3 and includes an infeed guide mechanism similar to the guide mechanism generally indicated at 67 and 72 as shown in FIGS. 3, 6 and 7 discussed hereinabove.

A pinch belt conveyor assembly shown generally at 144 transports the extracted plants such as the green onion 238 from the plant extractor 140 upwardly at an angle of approximately 35 degrees from the horizontal away from the seed bed 136. A rotating reorienting and discharging mechanism generally indicated at 146, receives the extracted onions from the exit end of the pinch belt convey assembly 144. The rotating reorienting and discharging mechanism 146 functions to reorient the onions disposed in a substantially vertical disposition such as an onion 239 to a substantially horizontal disposition such as an onion 248. The rotating reorienting and discharging mechanism 146 further includes the function of discharging the horizontally disposed onions such as the onion 148 to a collection location 150 which may, for example, be a container, tote or other.

The harvester 130 is able to harvest substantially all of the seed rows of the soil bed 136 in one swath or a multiple number thereof, by including a plurality of angularly disposed mechanisms (not shown) arranged side-by-side. Each mechanism could include a plant extractor, a pinch belt conveyor assembly, and a rotating reorienting and discharging mechanism, each having a similar structure and function as the others previously described herein.

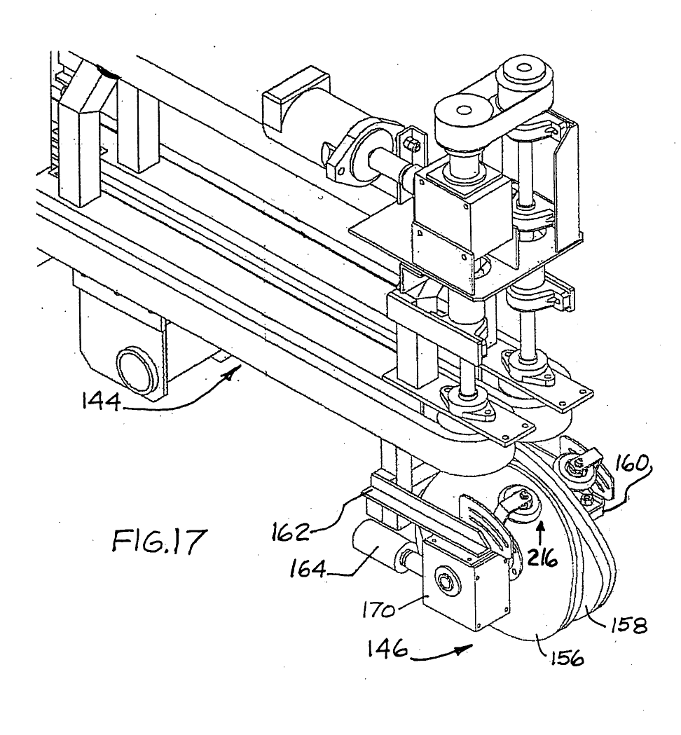

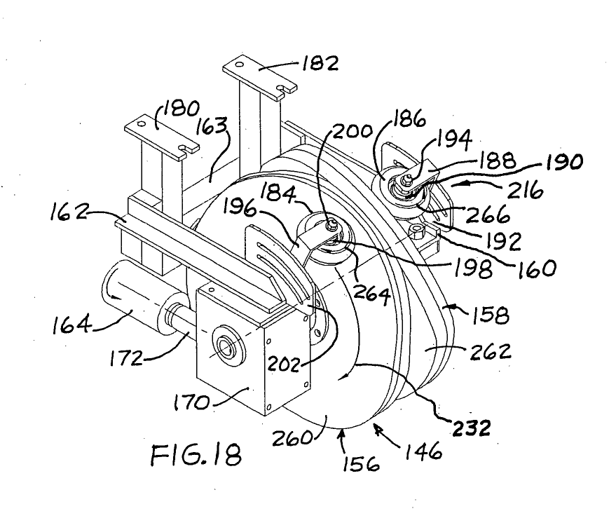

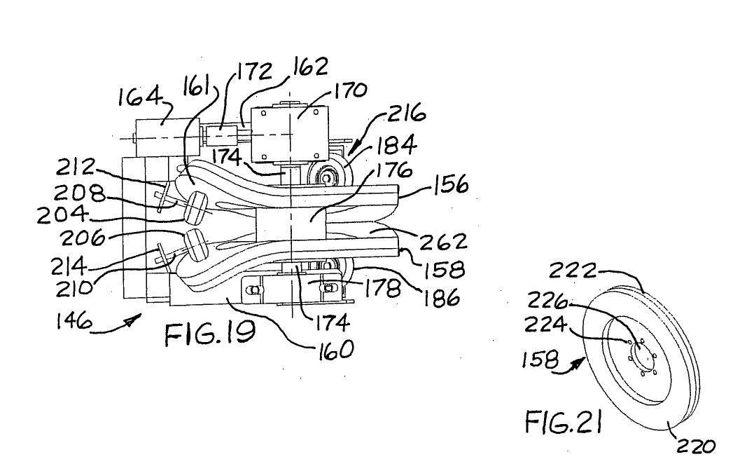

Referring now to FIGS. 17, 18 and 19, the reorienting and discharging mechanism generally includes a pair of flexible discs 156 and 158 are rotatably mounted in axial alignment to one another about a common generally horizontal axis. The flexible discs are further mounted on an axle 174 journaled for rotation between a gear box 170 and a bearing assembly 178. Each flexible disc may be composed of a suitable flexible material, such as polyurethane or other, that has a substantially perfect memory, meaning that when deformed under pressure, the disc returns to its unstressed disc shape when the pressure is removed. Each disc has an inner surface and an outer surface. Specifically, the disc 156 has outer surface 260 composed of the flexible material as best shown in FIG. 18, and an inner surface 161 composed of a soft spongy material such as a suitable foam material, as best shown in FIG. 19. The disc 158 has an inner surface 262 as best shown in FIGS. 18 and 19 and an outer surface (not shown), which may be similar to the outer surface 260.

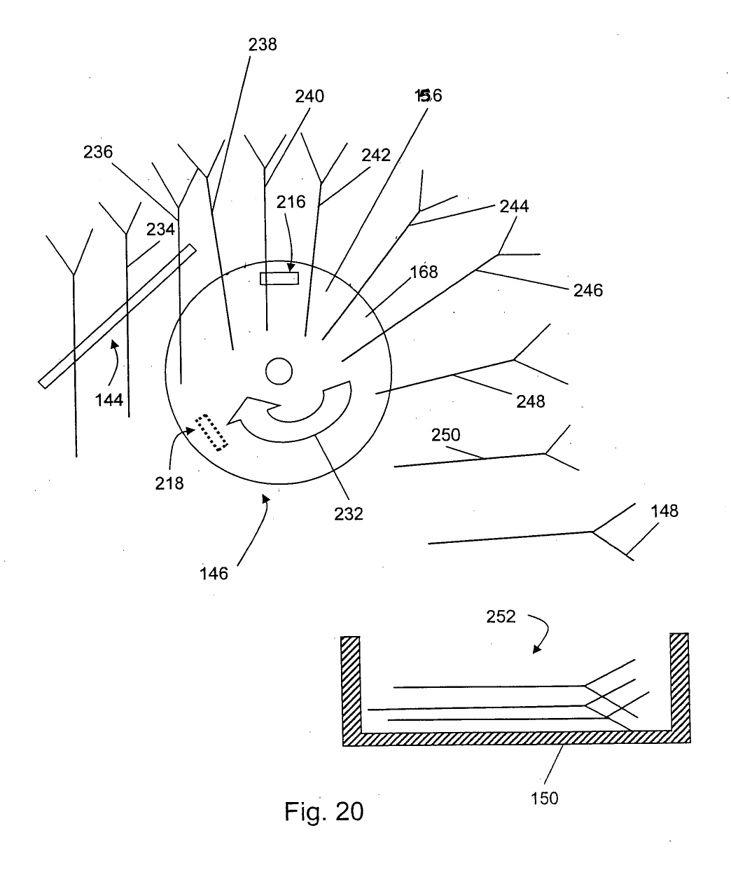

The reorienting and discharging mechanism 146 includes a pair of pinch rollers generally indicated at 216 and comprising rollers 184 and 186 (FIGS. 17, 18, 19 and 20) disposed at or near the uppermost portions of the discs 156 and 158 as best seen in FIG. 20. They urge the peripheries of the discs 156 and 158 toward one another to enable the onions to be received and grasped therebetween in a generally vertical disposition from the conveyor 144 seriatim. The speed of rotation of the discs 156 and 158 is coordinated with the speed of the conveyor 144 so that the individual onions are discharged from the conveyor 144 and are received individually between the pinched together rotating discs in a substantially continuous operation.

The mechanism 146 including the discs 156 and 158 together with the pinch rollers 216 serve as a reorienting device, since the onions are received in a generally vertical disposition and are angularly translated through about 90 degrees to a generally horizontal disposition. In order to serve as a discharge device, a pair of spreader rollers 218 may be disposed between the discs 156 and 158 at the underside thereof at about 230 degrees in a clockwise direction from the pinch rollers 216 as viewed in FIG. 20, and may cooperate with the discs to help insure that the rotating disc separate sufficiently to discharge the onions as they become generally horizontally disposed to fall into the container 150.

The rotating discs 156 and 158 thus wobble as they rotate. They are urged together at the upper portions thereof to receive and grasp the onions discharged from the conveyor 144 through about a segment of about 90 degrees, and then snap back toward their unstressed shape with the assistance of the spreader rollers 218. Once spread apart, they are able to receive the onions and then grasp them as the pinch rollers force the upper periphery of the discs 156 and 158 together.

The discs 156 and 158 are fixed facing one another in axial alignment on the axle 174 (FIG. 19). The two discs 156 and 158 are spaced slightly apart from one another when not deformed. When the discs are unstressed, the soft spongy inner surfaces 261 and 262 face each other. The flexible discs 156 and 158 are driven into rotation with the axle 174 via the gear box 170. A motive means 164 drives the axle 174 to rotate in the direction shown by arrow 232 (FIG. 18) via the gear box 170 and a coupling 172 to, in turn, drive the flexible discs 156 and 158 to rotate in the direction indicated by arrow 232 (FIG. 18). A hub 176 secures the two discs to the axle 174.

Considering now the rotating reorienting and discharging mechanism 146 in more detail and in reference to FIGS. 17 and 18, the rotating reorienting and discharging mechanism 146 includes a mounting beam 163, and mounting brackets 160 and 162 fixed to the beam 163 to help form a frame for the rotating reorienting and discharging mechanism 146. A set of mounting brackets 180 and 182 are connected to the beam 163 for mounting on the pinch belt conveyor assembly 144 near its upper exit end and serve to secure the rotating reorienting and discharging mechanism 146 in rigid positional alignment with the exit end below the pinch belt conveyor assembly 144.

Attached to the mounting bracket 162 is the gear box 170. The motive means 164 is drivingly coupled to the gear box 170 through the coupling 172. The motive means 164 may be any source of rotational power such as an electric motor, hydraulic motor, an engine, or other. The axle 174 is connected to the gear box 170 disposed at about ninety degrees from the input 164 for driving the discs 156 and 158.

As best shown in FIG. 19, the bearing assembly 178 is mounted to the mounting bracket 160. The assembly 178 is disposed in axial alignment with the output of the gear box 170.

As best seen in FIG. 18, the pinch rollers 184 and 186 may be rigidly mounted by angle brackets 196 and 188, respectively.

The pinch rollers 184 and 186 are rotatably mounted to the angle brackets through a pair of bearings 198 and 190 and a pair of mounting bolts 200 and 194 to provide a low friction pinch roller system. In order to mount the angle brackets to hold the pinch rollers in place, a pair of mounting plates 202 and 192 are vertically and fixedly mounted to mounting brackets 162 and 160, respectively. Angle brackets 196 and 188 may be fixedly and adjustably mounted to mounting plates 202 and 192, respectively.

As best seen in FIG. 19, a pair of spreader rollers 218, comprising spreader rollers 204 and 206, are angularly disposed and rotatably engaging the inner surfaces 261 and 262 of each flexible disk 156 and 158, respectively, to spread apart the discs as they rotate. Spreader rollers 204 and 206 are preferably disposed near the outer circumference or periphery of each flexible disc and journaled for rotation on shafts 208 and 210 fixed to mounting plates 212 and 214, respectively. The spreader rollers 204 and 206 are supported by the beam 163. Roller shafts 208 and 210 are mounted to the mounting plates 212 and 214, respectively, for positioning the rollers in engagement with the inner surfaces 161 and 262 of the flexible rotating discs 156 and 158.

In order to drop the plants in a generally horizontal disposition, the spreader rollers 204 and 206 serve to deform the flexible discs in an outward direction at the bottom portion of the rotating reorienting and discharging mechanism 146 to release the plants and permit them to drop under the force of gravity. As the flexible discs are deformed outwardly, they help form a discharging device for discharging and dropping the horizontally disposed plants that were reoriented by the reorienting device.

With reference to FIGS. 18, 19, and 20, when motive means 164 begins to rotate the flexible discs 156 and 158, in the direction shown by arrow 232, the pinch rollers 184 and 186 engage the outer surfaces of each disc driven to rotate in the directions shown by arrows 264 and 266, respectively. Spreader rollers 204 and 206 (FIG. 19) rotatably engaging the inner surfaces of each disc are also driven to rotate by the rotational motion of the flexible discs 156 and 158.

In operation as best seen in FIGS. 17 and 20, green onions, such as onion 234 are transported angularly upwardly by the pinch belt conveyor assembly 144 seriatim. As the onions reach the top of the conveyor 144, such as onion 236, the pinch belt conveyor assembly 144 propels the onions, such as onion 236 (FIG. 20), into the rotating reorienting and discharging mechanism 146. The mechanism 146 receives each green onion seriatim. As the onions, such as onion 238 enter the mechanism 146, the substantially vertically disposed onion is gripped between the two flexible discs 156 and 158 near the top thereof.

The mechanism 146 reorients the onions from a generally vertical disposition to a generally horizontal disposition through the rotation of the discs 156 and 158. For example, an onion 240 is gripped by the discs at the top parts thereof shortly after the mechanism 146 received the onion discharged from the conveyor assembly 144. As the discs continue to rotate in the clockwise direction indicated by arrow 232 of FIG. 20, the onion continues to be translated angularly by the rotation of the discs, gripped therebetween, to a generally horizontal disposition where it is discharged from the mechanism 146.

At the point where onion is being discharged from the mechanism 146, the flexible discs begin to diverge from each other for causing the onions to begin to be released from the discs and fall from the mechanism 146.

As best shown in FIG. 20, collection location 150 is positioned to receive the discharged onions such as the onions 248, 250, and 148. Collection location 150 receives the plurality of onions being discharged from the discharging device 168 and compiles a pile of onions 252 for further processing.

Considering the flexible discs in greater detail with reference to FIG. 21, the two flexible discs 156 and 158 are similar to each other, and thus, only the flexible disc 158 will now be described in greater detail. A spongy substance in the shape of a ring may be deposited or laminated on the outer surface 222 to form the spongy inner surface 220 of the disc 158 to form a composite. The inner surface 220 has the proper frictional properties to grip the plants while not damaging them.

The outer surface area 222 may be formed of a suitable flexible material such as polyurethane, having a perfect or substantially perfect memory. The properties of the material such as polyurethane permit the disc to be deformed when pressure is applied by pinch rollers 184 and 186 and spreader rollers 204 and 206. As pressure is released from the rollers, the material such as polyurethane enables the disc to spring back to its non-deformed disposition, and thus wobble back and forth as it rotates.

Flexible disc 158 further includes a central bore 226 sized to receive the hub 176. Flexible disc 158 additionally includes a plurality of hub mounting holes, such as mounting hole 224, are radially disposed around the bore 226.

While the present embodiments of the invention as disclosed herein have been particularly shown and described with reference to particular embodiments thereof, it will be understood by those skilled in the art that various changes in form and details may be made therein without departing from the true spirit and scope of the present invention.

1. An apparatus for harvesting plants extracted from the soil and transported them onto the apparatus in a generally vertical disposition, comprising:
a reorienting and discharging mechanism having an input end and an output end;
the mechanism includes a first device for reorienting the plants extracted from the soil received in a generally vertical disposition to a generally horizontal disposition and a second device for dropping the horizontally disposed plants to a collection location.

2. An apparatus as recited in claim 1, wherein the reorienting device includes a pneumatic product transfer tube.

3. An apparatus as recited in claim 1, wherein the reorienting device includes a product separator.

4. An apparatus as recited in claim 1, wherein the reorienting device includes a pair of rotating flexible discs.

5. An apparatus as recited in claim 1, wherein the first device of the reorienting device includes a pair of pinch rollers.

6. An apparatus as recited in claim 1, wherein the second device of the reorienting device includes a pair of spreader rollers.

7. An apparatus as recited in claim 1, wherein the plants are green onions.

8. A method for harvesting plants extracted from the soil and transported singly up onto the apparatus in a generally vertical disposition, comprising:
reorienting the plants extracted from the soil from an approximate vertical disposition to an approximate horizontal disposition; and
dropping the horizontally disposed plants to a collection location.

9. An apparatus for harvesting plants extracted from the soil and transported them onto the apparatus in a generally vertical disposition, comprising:
means for reorienting the plants extracted from the soil from a generally vertical disposition to a generally horizontal disposition; and
means for dropping the horizontally disposed plants to a collection location.

10. An apparatus as recited in claim 9, wherein said means for reorienting includes a pneumatic product transfer tube having an input end and an output end; a mounting bracket attached to the tube; and a pump for creating a vacuum in the tube.

11. An apparatus as recited in claim 10, wherein said means for dropping includes a product separator having a housing and an interior section formed therein, the interior section being in fluid communication with the output end of the tube.

12. An apparatus as recited in claim 11, wherein the product separator further includes a drop gate.

13. An apparatus as recited in claim 11, wherein the product separator further includes a sealed discharge conveyor belt.

14. An apparatus as recited in claim 11, further including a negative air pressure plenum being in fluid communication to the product separator and a fan in fluid communication to the plenum for creating negative air pressure therein.

15. An apparatus as recited in claim 9, wherein said means for reorienting a pair of flexible discs, the pair of flexible discs having an input portion and an output portion; a mounting bracket attached to the flexible discs; motive means for rotating the flexible discs; and a pair of pinch rollers for urging the discs toward one another along a portion of the periphery thereof.

16. An apparatus as recited in claim 15, wherein the flexible discs includes:
a first and second discs, each formed of material having a memory, and each disc further having an inner surface and an outer surface;
the discs disposed in an axial relationship to each other and the inner surfaces of each disc facing each other; and
the pair of pinch rollers disposed in an opposing relationship, the rollers engaging the outer surfaces of the discs.

17. An apparatus as recited in claim 16, wherein the inner surface of each disc is comprised of foam.

18. An apparatus as recited in claim 16, wherein the outer surface of each disc is composed of polyurethane having an approximate perfect memory.

19. An apparatus as recited in claim 15, wherein the means for dropping includes a pair of spreader rollers at the output portion of the discs.

20. An apparatus as recited in claim 15, wherein:
the pair of discs are each formed of material having a memory, and each disc further having an inner surface and an outer surface;
the discs are disposed in an opposing axial relationship to each other, the inner surfaces of each disc facing each other;
the pair of pinch rollers are disposed in an opposing relationship, the rollers engaging the outer surfaces of the discs; and
a pair of spreader rollers disposed in an opposing relationship disposed at least approximately 45 degrees away from the pair of pinch rollers, the rollers engaging the inner surfaces of the disc.

21. A method for harvesting plants extracted from the soil and transported singly up onto the apparatus in a generally vertical disposition, comprising:
mounting a pneumatic product transfer tube having an input end and an output end;
creating a vacuum within the tube;
placing the plants removed from the soil near the input end of the tube causing the plants to be drawn into the input tube and discharged from the output end of the tube.

22. A method as recited in claim 15, further including collecting the plants ejected from the output end of the tube into a product separator.

23. A method as recited in claim 16, further including forming a vacuum within the product separator.

24. A method for harvesting plants removed from the soil by a plant extractor and transported onto a harvesting apparatus in a generally vertical disposition, comprising:
reorienting the plants being received in a generally vertical disposition using a first device; and
dropping the reoriented plants in a generally horizontal disposition to a collection location.

25. A method as recited in claim 18, wherein the reorienting includes placing the plants removed from the soil near the input end of the tube causing the plants to be drawn into the input tube and discharged from the output end of a vacuum tube, and wherein the dropping includes collecting the plants ejected from the output end of the tube into a product separator.

26. A method as recited in claim 19, further including forming a vacuum within the product separator.

27. A method as recited in claim 24, wherein the reorienting includes:
mounting for rotation a pair of discs having an input portion and an output portion;
rotating the pair of discs;
pressing the discs toward one another along a portion of the periphery of the discs for gripping the plants.

28. A method as recited in claim 27, wherein the dropping includes spreading apart the discs.
